(19) United States
(12) Patent Application Publication
(10) Pub. No.: US 2012/0017442 A1
(43) Pub. Date: Jan. 26, 2012

(54) Magnetic Handle Scales for Folding Tool

(76) Inventor: Paul G. King, Lebanon, NH (US)

(21) Appl. No.: 13/181,634

(22) Filed: Jul. 13, 2011

Related U.S. Application Data
(60) Provisional application No. 61/367,571, filed on Jul. 26, 2010.

(51) Int. Cl. B26B 1/10; B26B 1/02

(52) U.S. Cl. 30/155; 30/164

(57) ABSTRACT

A pair of handle scales are configured to mate against the liners of the core assembly of a folding tool such as a pocket knife. A mating surface of each scale can have recesses to accommodate extending pins on which the blades of the tool pivot. A magnetic moment is provided between the scales to attract the scales together, forcibly engaging them against the core assembly positioned therebetween. The magnetic moment can be provided by one or more magnets in each scale, positioned to be opposed when the scales are superimposed on the liners. The scales can each be formed as a two-part assembly having a scale plate which contacts the core and a scale body, which can be provided with recesses to store accessories.

### FIELD OF THE INVENTION

The present invention relates to folding pocket tools such as knives, and more particularly to an improved set of handle scales for such tools.

### BACKGROUND OF THE INVENTION

Folding tools such as knives designed for carry in the pocket of the user have one or more blades that are hinged, so as to fold into a storage position, where the blade resides within a handle of the tool, and an open position, where the blade extends from the handle for use. The handles of such tools are provided with a pair of scales that can provide a comfortable grip and/or a decorative appearance. These scales are permanently affixed to the remainder of the handle by mechanical fasteners.

Magnets have been incorporated into pocket knives for various functions associated with securing the blade in position relative to the handle or handle components. U.S. Publication 2007/0193036 teaches a magnetic post that aids in moving the blade of a folding knife into either the extended or closed position, while U.S. Pat. No. 7,578,064 teaches a magnetic element to bias a blade-locking element. U.S. Pat. No. 6,195,898 teaches a magnetic element used to maintain two independently swiveling handle components of a “butterfly” knife together when the blade is either extended or housed within the handles. Additionally, magnets have been employed in disposable-blade utility knives, either to facilitate separating two handle halves in order to ease blade changes (as taught in U.S. Pat. Nos. 6,865,816 and 7,100,285), or to retain elements in place within the hollow handle when the handles are separated (as taught in U.S. Pat. Nos. 5,301,428 and 6,233,830).

### SUMMARY OF THE INVENTION

The present invention provides a set of handle scales for a tool such as a folding knife that can be readily replaced and which are well suited to retrofitting onto an existing folding knife. The attachment of the handle scales to a core assembly of the knife can be readily achieved without requiring the use of tools or adhesives.

The core assembly of the folding knife for which the handle scales are designed to be used has a pair of substantially planar liners, with a number of blades or tools pivotably mounted so as to be stored between the liners. The blades or tools pivot on pins that extend between the liners and to which the liners are affixed so as to be maintained in a parallel, spaced-apart relationship. Typically, the pins extend through and beyond the liners so as to form protrusions. Such core assemblies typically have two pins for mounting the blades or tools. A third pin is frequently also provided, to support a spring that serves a two-fold purpose; first, it serves to bias the blade to remain in either a closed position or an open position, and secondly it serves as a stop when the blade has reached the open position.

The set of handle scales has a first handle scale and a second handle scale. The first handle scale has a first base surface that is configured to mate against the first liner, while the second handle scale has a second base surface that is configured to mate against the second liner. For those pins that extend beyond the liners so as to form protrusions, each of the handle scales is provided with recesses that are located and configured to accept such protrusions, in order to allow the base surface to mate flat against the liner from which the protrusions extend. The recesses can slidably engage the protrusions so as to stabilize the position of the handle scale on the core assembly. The recesses can be provided with wear-resistant bushings of metal, durable scuff resistant plastic, or similar material to prevent wear caused by engagement with the protrusions over time which would otherwise reduce the registry of the alignment of the handle scales with liners of the core assembly of the knife. Alternatively, the handle scales can each be fabricated as a two-part assembly having a scale plate which contacts the core and has passages which engage the protrusions. These scale plates are fabricated from durable, abrasion-resistant material, preferably metal, and eliminate the need for wear-resistant bushings.

The handle scales are maintained against the liners of the core assembly by permanent magnets that provide a magnetic moment between the first handle scale and the second handle scale. These magnets are positioned such that the handle scales are attracted together and forcibly engage their base surfaces against the liners of the core assembly. While the handle scales can be formed entirely from a magnetic material, it is preferred that the handle scales employ one or more pairs of magnets that reside in recesses in the handle scales. By so doing, the class of materials that can be used to form the handle scales is no longer limited to magnetic materials, allowing greater freedom in selecting the material for the handle scales and allowing such materials as wood or plastic.

When one or more pairs of magnets are employed, the magnets of each pair are typically positioned such that, when the handle scales are engaged with the liners of the core assembly, the magnets in the pair are substantially opposed to each other with their magnetic fields aligned. Using two pairs of magnets, one located near either end of the handle scales, has been found to provide a desirable degree of stability for maintaining the handle scales engaged with the core assembly. While the opposed magnets can be strong enough to provide a sufficient magnetic moment to maintain the base surfaces engaged against their respective liners, the retention of the handle scales can be enhanced when at least a portion of the core assembly is formed from ferromagnetic material. Frequently, retaining springs, blades, and other tools of the folding knife are formed from a ferromagnetic steel. The magnets in the handle scales are attracted to these elements, generating an induced magnetic moment in the core assembly which interacts with the opposing magnet. This serves to further strengthen the attraction of the base surfaces against the liners. To enhance this effect for a knife with ferromagnetic blades even when the knife is in use, the magnets should be placed in close proximity to the pins on which the blades pivot so that at least a portion of the blade will remain in close proximity to the magnet whether the blade is in its closed or open position. Again, when the scales are two-part structures, it is advantageous to have the scale plates made from a ferromagnetic material.

An additional benefit of the set of handle scales that each has a magnet located near each end can be obtained when the core assembly has ferromagnetic elements, and where the individual magnets in each of the handle scales have sufficient strength to maintain the handle scale against the respective liner even without the corresponding magnet of the other handle scale being opposed thereto. This condition allows one of the handle scales to be placed with its base surface against the liner but not matched up so as to be completely superimposed thereon; instead, the handle scale can be maintained by one of the magnets against the liner in an extended position, where only a portion of the handle scale is superimposed on the liner and the remainder extends beyond the core assembly. This leaves the magnet that is located near the extending end of the handle scale free, where it can be employed as a pick-up tool for retrieving small ferromagnetic parts from crevices or similar areas where access space is limited. For further reach, the other one of the set of handle scales can be employed, with one of its magnets magnetically attached to the exposed magnet of the first handle scale and its other magnet exposed.

Another advantage of the handle scales of the present invention can be obtained when the magnetic moment provided by the magnets is sufficiently strong to support the weight of the knife, as this can allow the knife to be conveniently stored by magnetically attaching it to a ferromagnetic surface such as a steel cabinet.

### BRIEF DESCRIPTION OF THE FIGURES

FIG. 1 is an exploded isometric view showing a folding knife that forms one embodiment of the present invention. The knife has a conventional core assembly containing a number of blades (or tools) that pivot on pins and are positioned between two liners. Two handle scales (which are magnetized) attach onto the core assembly, and are designed so as to be magnetically attracted together by a magnetic moment that is sufficient to maintain the handle scales against the core assembly that is interposed therebetween. In this embodiment, centrally-positioned magnets are employed to magnetically attract the handle scales together.

FIG. 2 is an isometric view of the knife shown in FIG. 1 when assembled. Each of the handle scales has a base surface with an array of recesses positioned and configured to accept protrusions on the core assembly to allow the base surface to mate against one of the liners. When the base surfaces of both handle scales are positioned against their respective liners, the magnets in the handle scales are aligned with each other and are further oriented such that their magnetic fields are aligned, as better shown in FIG. 3.

FIG. 3 is an isometric view of the magnets employed in the handle scales of the knife shown in FIGS. 1 and 2, illustrating the polarity of the magnets that allows them to magnetically attract the handle scales toward each other into engagement with the liners of the core assembly.

FIG. 4 is an exploded isometric view of a pair of handle scales that form another embodiment of the present invention. The pair of handle scales is suitable for retrofitting to replace the handles of a conventional folding knife having a core assembly, shown in phantom. In this embodiment, each of the handle scales has a pair of magnets, with one positioned near each end of the handle scale so as to provide a more secure and stable attraction between the handle scales. This embodiment also employs bushings in recesses in the handle scales, into which protrusions on the core assembly reside to prevent undue wear by the protrusions on the recesses in the handle scales.

FIG. 5 is an isometric view of the pair of handle scales shown in FIG. 4 when assembled to be applied to the folding knife. FIG. 5 also illustrates the polarity of the magnets.

FIGS. 6 and 7 illustrate the handle scales shown in FIGS. 4 and 5 when employed on a knife which is magnetically attractive in an arrangement where they provide a magnetic pick-up tool; FIG. 6 shows the handle scales before attachment, while FIG. 7 shows the assembled pick-up tool. As shown in FIG. 7, a first one of the handle scales is magnetically attached onto the knife in an extended position, where it extends beyond the knife so as to leave one of the magnets exposed. The first handle scale is stabilized by the engagement of two of the recesses with a corresponding two protrusions on the knife. The second handle scale is magnetically attached with one of its magnets mated against the exposed magnet of the first handle scale. The remaining magnet of the second handle scale is then left free to serve as a pick-up tool for retrieving small magnetically-attractive parts.

FIGS. 8 and 9 illustrate another embodiment of the present invention, where each of the handle scales is a two-part structure having a scale plate and a scale body attached thereto.

### DETAILED DESCRIPTION

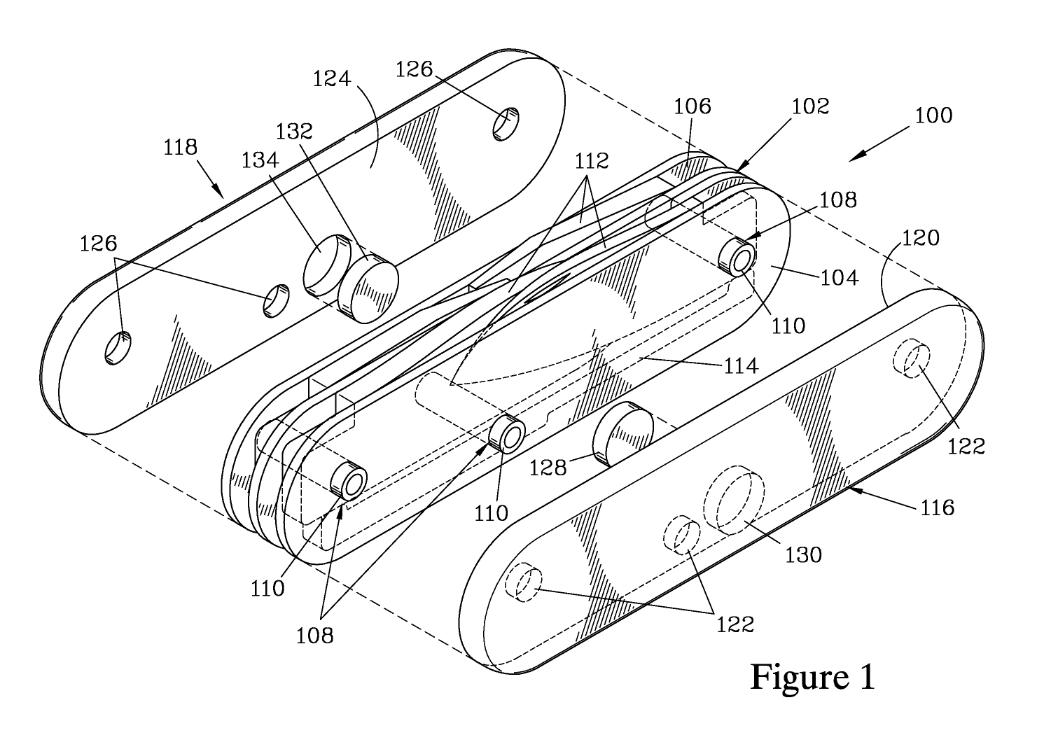

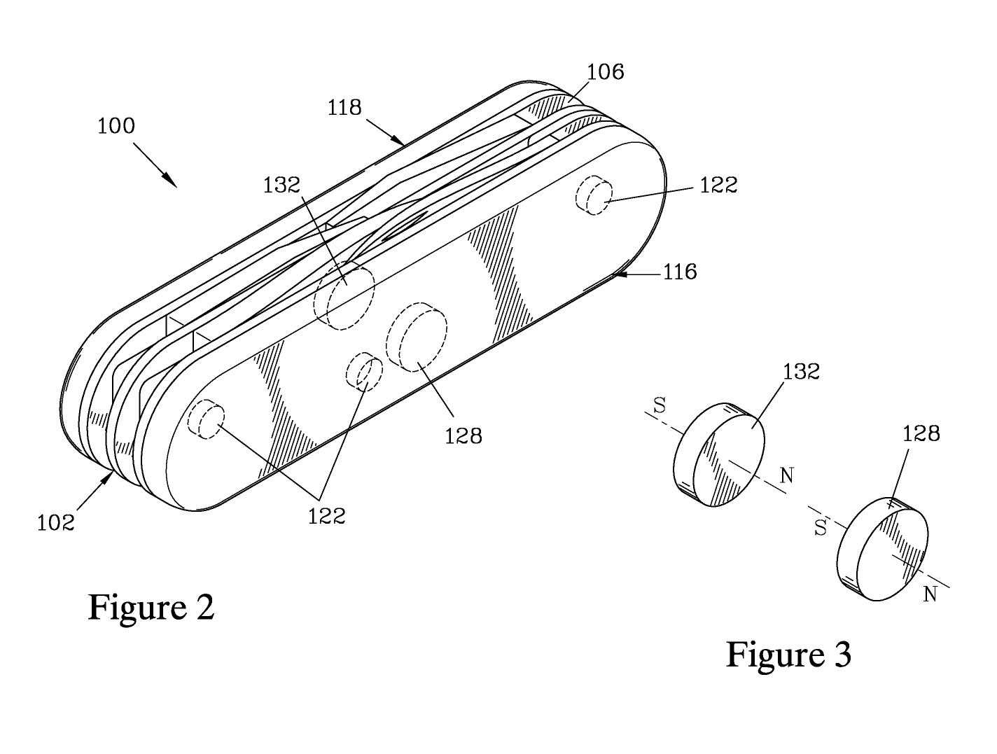

FIGS. 1 and 2 illustrate a folding knife 100 that forms one embodiment of the present invention. The folding knife 100 has a core assembly 102 that is similar to those of conventional folding knives, having a substantially planar first liner 104 and a substantially planar second liner 106, which extends parallel to the first liner 104 and is spaced apart therefrom. The liners (104, 106) are fastened together by a series of pins 108 that extend between the liners (104, 106) to maintain them in their relative positions. The pins 108 extend beyond each of the liners (104, 106) so as to form a series of first liner protrusions 110 (shown in the exploded view of FIG. 1) that extend beyond the first liner 104 and a series of second liner protrusions (not visible) that extend beyond the second liner 106. The pins 108 also serve to pivotably attach a number of blades 112 (and other tools, hereinafter simply referred to as blades) that can each move between a closed position (as shown), where the blade 112 resides between the first and second liners (104, 106), and an open position (not shown), where the blade 112 extends substantially beyond the first and second liners (104, 106). One or more spring bars 114 (see FIG. 1, which illustrates only one in hidden lines) serve to springably secure the blades 112 in the closed and open positions, in the manner well known in the art.

The knife 100 has a first handle scale 116 and a second handle scale 118 that are removably attachable to the core assembly 102. The first handle scale 116 has a first base surface 120 that is configured to mate against the first liner 104. The first handle scale 116 has a series of first scale recesses 122 (shown in hidden lines) that terminate at the first base surface 120 and which are configured and located so as to accept the first liner protrusions 110 when the first base surface 120 is mated against the first liner 104 and superimposed thereon (as shown in FIG. 2). The first scale recesses 122 can be configured to slidably engage the first liner protrusions 110 so as to stabilize the first handle scale 116 and maintain alignment of the first base surface 120 with the first liner 104.

Similarly, the second handle scale 118 has a second base surface 124 that is configured to mate against the second liner 106. The second handle scale 118 has a series of second scale recesses 126 (shown in FIG. 1) terminating at the second base surface 124, and configured and located so as to accept the second liner protrusions when the second base surface 124 is mated against the second liner 106. Again, the second scale recesses 126 can be configured to slidably engage the second liner protrusions to stabilize the second handle scale 118 and maintain alignment of the second base surface 124 with the second liner 106.

To removably attach the handle scales (116, 118) to the core assembly 102, a magnetic moment is provided between the first handle scale 116 and the second handle scale 118 are provided. This magnetic moment causes the first handle scale 116 and the second handle scale 118 to be attracted together so as to forcibly engage their base surfaces (120, 124) against the liners (104, 106) when placed in close proximity thereto. In the knife 100, the magnetic moment is provided by a first scale magnet 128, which resides in a first scale magnet recess 130 in the first handle scale 116, and a second scale magnet 132, which resides in a second scale magnet recess 134 in the second handle scale 118. The first scale magnet recess 130 and the second scale magnet recess 134 are located such that they are directly opposed when the first base surface 120 is mated against the first liner 104 and the second base surface 124 is mated against the second liner 106 (as shown in FIG. 2). Thus, the magnets (128, 132) are directly opposed and can be oriented so as to be magnetically attracted together, urging the handle scales (116, 118) toward each other and thus into forcible engagement with the core assembly 102 that is interposed therebetween. The magnets that are employed should be rare earth magnets such as neodymium magnets to maximize the strength of the attraction between the scales (116, 118).

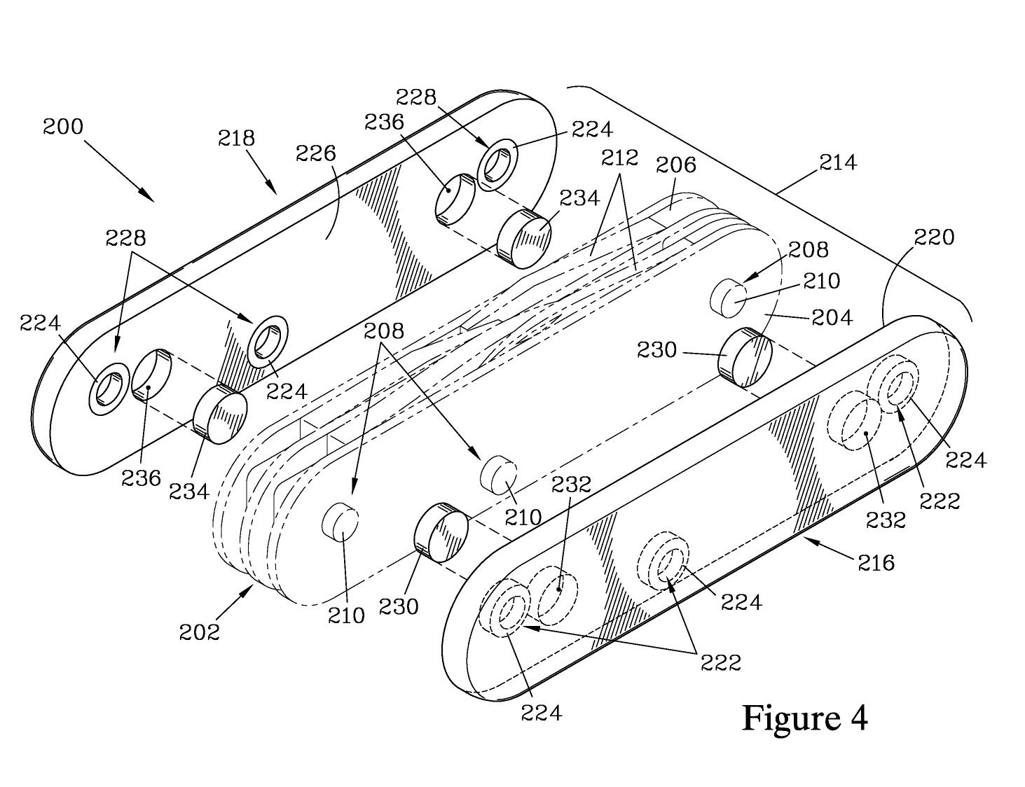

FIG. 3 illustrates one example of the polarity of the magnets (128, 132) that will provide the desired attraction. The magnets (128, 132) are oriented with their magnetic fields aligned. Thus, when the first base surface 120 is mated against the first liner 104 and the second base surface 124 is mated against the second liner 106, the North pole of one magnet (128 or 132) is directed toward the South pole of the other (132 or 128), and the opposite poles attract to provide the magnetic moment.

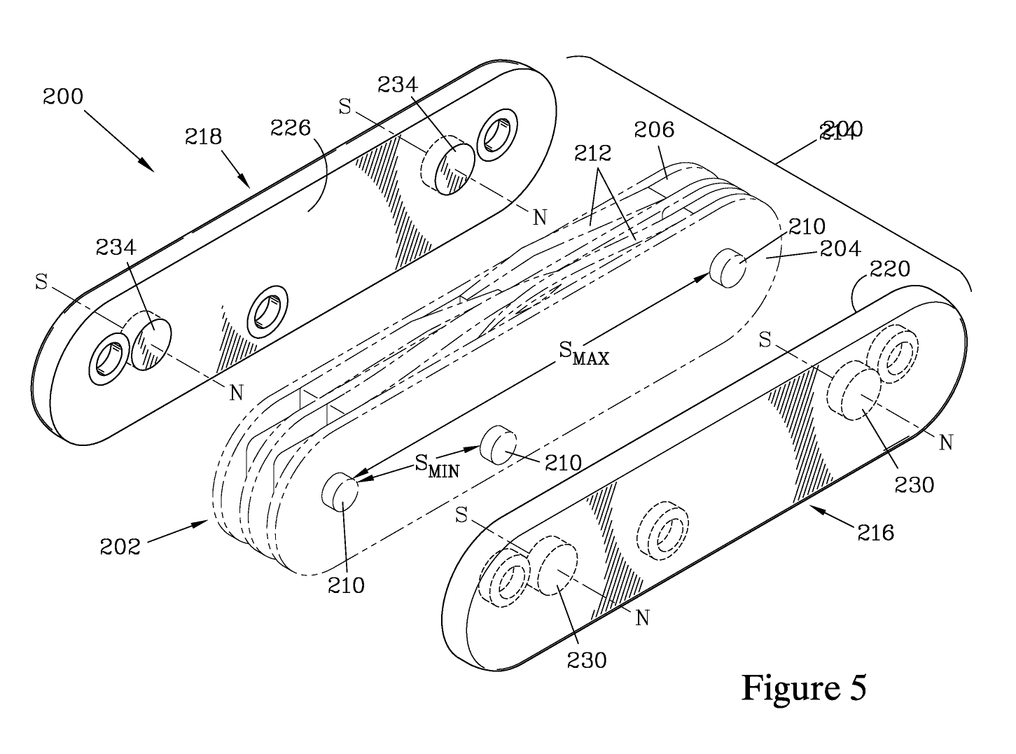

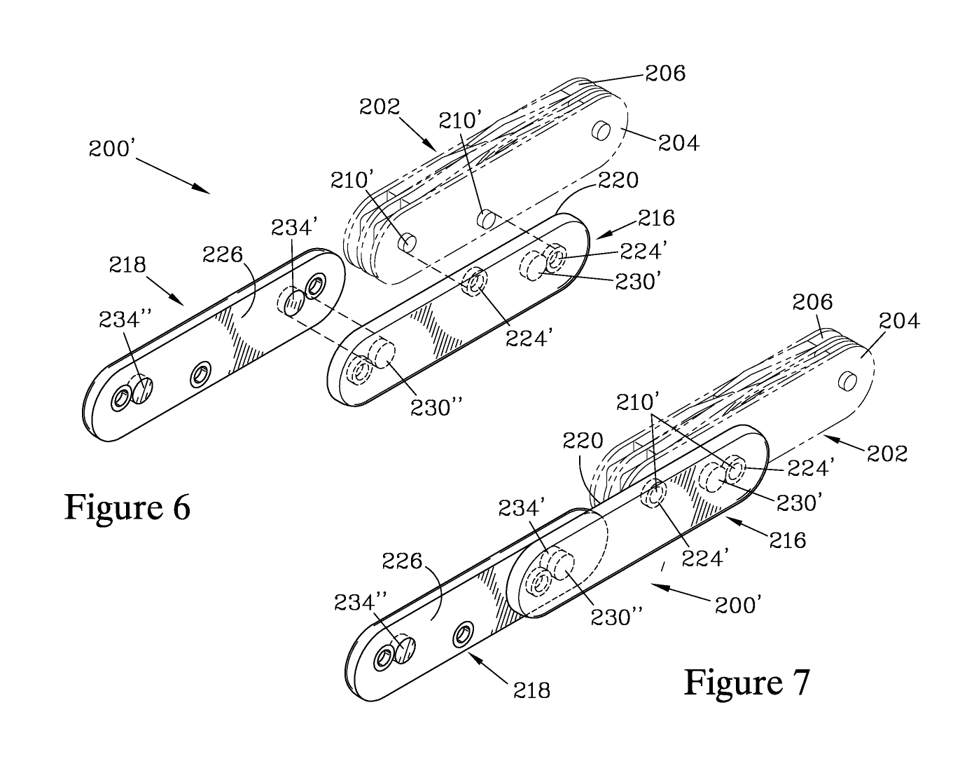

FIGS. 4 and 5 illustrate another embodiment of a folding knife 200 of the present invention. The folding knife 200 has a core assembly 202 (shown in phantom) that is similar to those of conventional folding knives, having a substantially planar first liner 204 and a substantially planar second liner 206. The liners (204, 206) are fastened together by a series of pins 208 that extend between the liners (204, 206) and maintain them in a parallel, spaced apart relationship. The pins 208 extend beyond each of the liners (204, 206) so as to form a series of first liner protrusions 210 (shown in the exploded view of FIGS. 4 and 5) that extend beyond the first liner 204 and a series of second liner protrusions (not visible) that extend beyond the second liner 206. The pins 208 also serve to pivotably attach a number of blades (and other tools) 212 that can each move between a closed position (as shown), where that particular blade 212 resides between the first and second liners (204, 206), and an open position (not shown), where the blade 212 extends substantially beyond the first and second liners (204, 206). One or more locking springs (not shown) serve to springably secure the blades 212 in either the closed or the open position, in the manner well known in the art.

The knife 200 also has a set of handle scales 214 that includes a first handle scale 216 and a second handle scale 218 that are removably attachable to the core assembly 202. The set of handle scales 214 could be employed to replace worn or damaged handle scales removed from the core assembly 202 to form the folding knife 200, when the core assembly 202 is provided by a preexisting knife. In any case, the first handle scale 216 has a first base surface 220 that is configured to mate against the first liner 204. The first handle scale 216 has a series of first scale recesses 222 (shown in hidden lines) that terminate at the first base surface 220 and which are configured and located so as to accept the first liner protrusions 210 when the first base surface 220 is mated against the first liner 204 and fully superimposed thereon. The first scale recesses 222 are fitted with bushings 224 that are configured to slidably engage the first liner protrusions 210 so as to stabilize the first handle scale 216 and maintain alignment of the first base surface 220 with the first liner 204.

Similarly, the second handle scale 218 has a second base surface 226 that is configured to mate against the second liner 206. The second handle scale 218 has a series of second scale recesses 228 terminating at the second base surface 226, which are configured and located so as to hold bushings 224 that accept the second liner protrusions when the second base surface 226 is mated against the second liner 206 and fully superimposed thereon. Again, the bushings 224 are configured to slidably engage the second liner protrusions to stabilize the second handle scale 218 and maintain alignment of the second base surface 226 with the second liner 206. The used of the bushings 224 reduces the wear and assures a long service of the handle scales (216, 218).

The embodiment shown in FIGS. 4 and 5 also differs in the details of the magnets employed to create a magnetic moment between the first handle scale 216 and the second handle scale 218. Again, the magnetic moment causes the first handle scale 216 and the second handle scale 218 to be attracted together so as to forcibly engage their base surfaces (220, 226) against the liners (204, 206) when placed in close proximity thereto. In the knife 200, the magnetic moment is created by a pair of first scale magnets 230, which resides in a pair of first scale magnet recesses 232 in the first handle scale 216, and a pair of second scale magnets 234, which resides in a pair of second scale magnet recesses 236 in the second handle scale 218. Each of the pairs of magnets (230, 234) are spaced apart and located in close proximity to those of the bushings 224 that are at the greatest separation (S_{MAX}, indicated in FIG. 5) in each of the handle scales (216, and 218) The pair of first scale magnet recesses 232 and the pair of second scale magnet recesses 236 are located such that they are directly opposed when the first and second base surfaces (220, 226) are respectively mated against the first and second liners (204, 206). Thus, the pairs of magnets (230, 234) are directly opposed and can be oriented (as shown in FIG. 5) with their magnetic fields aligned so as to be magnetically attracted together, urging the handle scales (216, 218) towards each other and thus into forcible engagement with the liners (204, 206) of the core assembly 202.

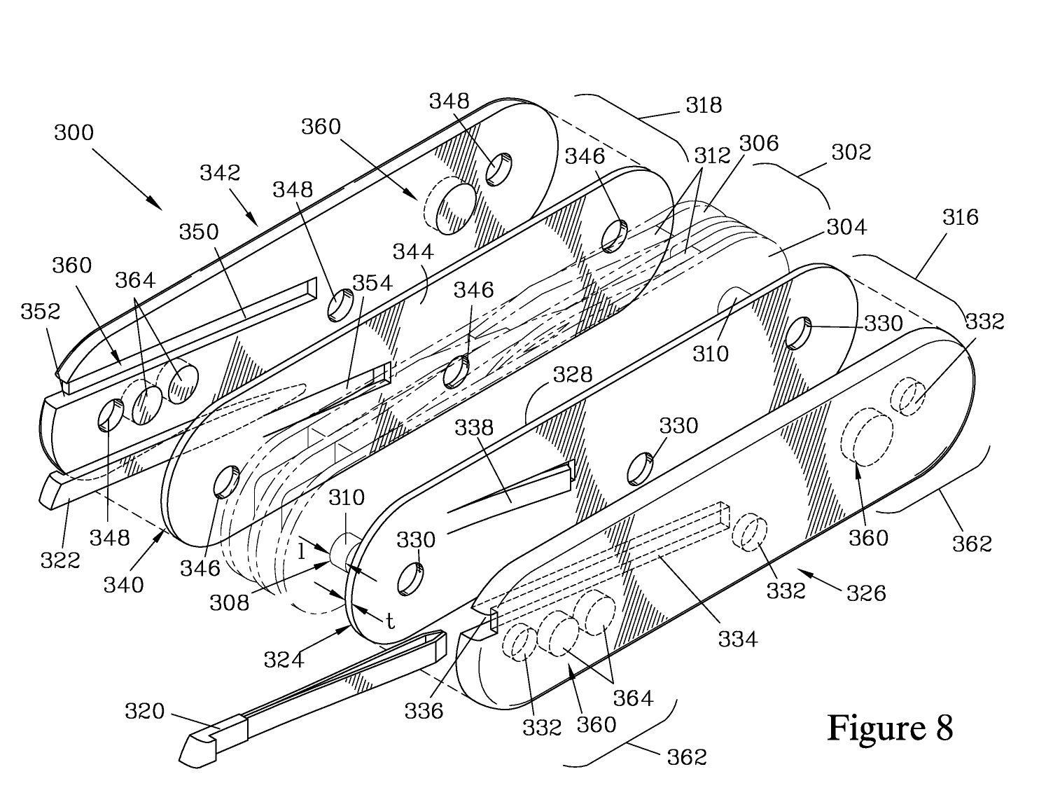

It has been found that employing rare earth magnets, such as neodymium magnets, for the magnets (230, 234) provides a magnetic moment of sufficient strength that when brought into close proximity to the liners (204, 206), the magnets (230, 234) maintain each of the handle scales (216, 218) against the respective liners (204, 206) of the core assembly 202. For a conventional pocketknife such as those offered under the trademark Victorinox™, it has been found that using neodymium disc magnets that are 1/16″ thick and ⅜″ diameter for the magnets (230, 234) provides a desirably strong magnetic moment to maintain the handle scales (216, 218) in position, and the thin, cylindrical configuration of such magnets is well suited for incorporation into the handle scales, as the recesses (232, 236) for such cylindrical magnets can be readily provided by milling. When greater magnetic moment is desired, larger sizes can be employed, and it has been found practical to employ 1/16″ thick×½″ diameter neodymium disc magnets for such pocket knives. One advantage of the present invention that can be enhanced by the use of stronger magnets is shown in FIGS. 6 and 7 and discussed below.

When the core assembly 202 is formed at least in part from a ferromagnetic material, the handle scales (216 and 218) can also be configured with the core assembly 202 as shown in FIGS. 6 and 7 to provide a magnetic pick up tool 200′ suitable for reaching into tight spaces to retrieve small ferromagnetic parts such as screws, nuts, washers, etc.

To form the magnetic pick-up tool 200′, the first handle scale 216 is mated against the core assembly 202 in an extended position, where only a portion of the first base surface 220 resides against the first liner 204, with the remainder extending therebeyond. In this position, a pair of the first liner protrusions 210′ that are separated by a minimum separation S_{MIN} (indicated in FIG. 5) are engaged with a pair of bushings 224′ in the first handle scale 216 and held in position, in part, by the magnetic moment interaction of one of the first scale magnets 230′ with the core assembly 202. The other of the first scale magnets 230″ is exposed and resides beyond the core assembly 202, where it may be inserted into a restricted space to retrieve a part while the user holds the core assembly 202.

While the exposed first scale magnet 230′ may be positioned sufficiently far from the core assembly 202 to allow reaching a sufficient distance into a restricted space, for many applications a further extension will be needed. Such can be provided by attaching the second handle scale 218 onto the first handle scale 216, by attaching one of the second scale magnets 234′ onto the exposed first scale magnet 230″ with the other of the second scale magnets 234″ being left exposed in a position where it can be inserted into a restricted space.

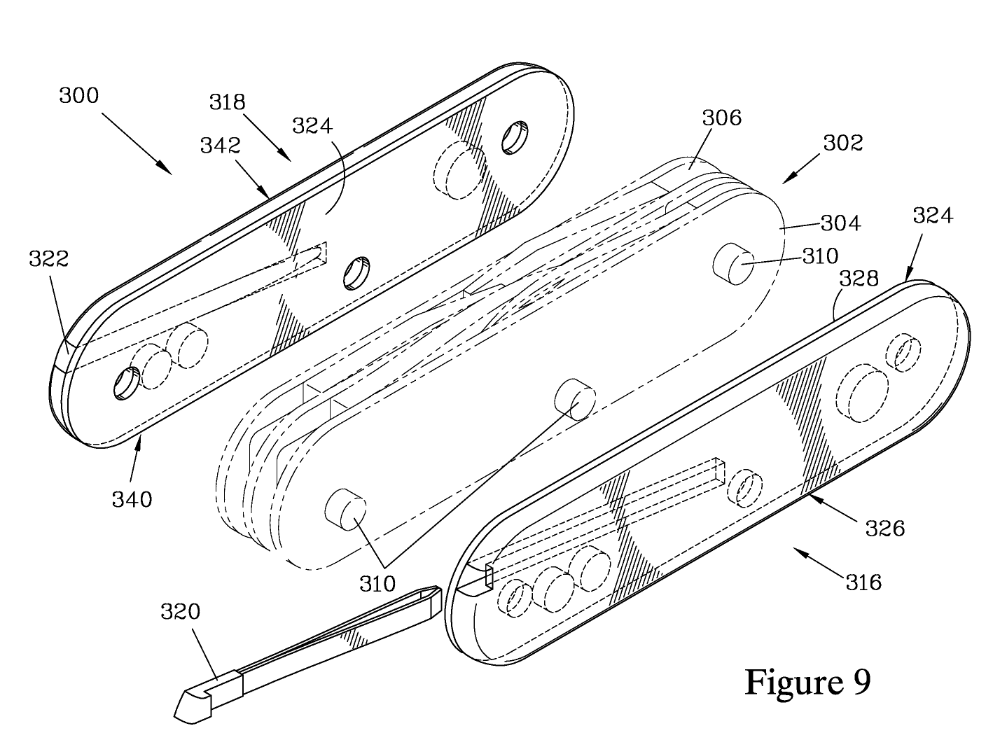

FIGS. 8 and 9 illustrate a folding knife 300 that forms another embodiment of the present invention. The folding knife 300 again has a core assembly 302 (shown in phantom) that is similar to those of conventional folding knives, having a substantially planar first liner 304 and a substantially planar second liner 306. The liners (304, 306) are fastened together by a series of pins 308 that extend between the liners (304, 306) to maintain them in a parallel, spaced apart relationship and which extend therebeyond to form a series of first liner protrusions 310 that extend beyond the first liner 304 and a series of second liner protrusions (not visible) that extend beyond the second liner 306. The pins 308 also serve to pivotably mount a number of blades (and other tools) 312.

The knife 300 again has a first handle scale 316 and a second handle scale 318 that are removably attachable to the core assembly 302 and collectively form a set of handle scales. In this embodiment, the set of handle scales are designed to house supplementary tools such as a pair of tweezers 320 and a toothpick 322, such as are frequently provided as supplementary tools for folding knives made by Victorinox.

The first handle scale 316 for this embodiment has a two-part structure, having a first scale plate 324 that is affixed to a first scale body 326. This scale plate 324 is preferably made of a durable, abrasion-resistant material such as metal for reasons set forth below. The first scale body can be made from a less durable material such as plastic or wood. A first base surface 328 is provided by the first scale plate 324, and is configured to mate against the first liner 304.

The first scale plate 324 has a series of first plate passages 330 that are positioned and configured to slidably engage the first liner protrusions 310 when the first base surface 328 is mated against the first liner 304 and fully superimposed thereon. The first scale body 326 may be provided with a series of first scale recesses 332 (shown in hidden lines) that communicate with and extend the first plate passages 330 when the first handle scale 316 is assembled as shown in FIG. 9. The need for such will be dictated by the thickness t of the first scale plate 324 and the length l of the first liner protrusions 310. Since the first scale plate 324 is made from a durable material, bushings such as are employed in the knife 200 discussed above are unnecessary to prevent wear.

The first scale body 326 is provided with a first body recess 334 configured to accommodate one of the supplementary tools (320, 322). The first body recess 334 is positioned so as to be partially bounded by the first scale plate 324 when the first handle scale 316 is assembled, and has a first body recess opening 336 through which the supplemental tool (as illustrated, the tweezers 320) can be inserted into the first scale recess 334 for storage. The tweezers 320 may have sufficient resiliency in their fit in the first scale recess 334 to serve to retain them therein. However, more positive retention can be provided by forming the first scale plate 324 with a first plate retention spring 338 that is compressed when the tweezers 320 are inserted into the first scale recess 334, and thus applies a force to the tweezers 320 to prevent them from falling out.

The second handle scale 318 also has a two-part structure, having a second scale plate 340 affixed to a second scale body 342. The second scale plate 340 is formed from a durable, abrasion-resistant material and has a second scale base surface 344 for mating against the second liner 306, and a series of second plate passages 346 configured and positioned to slidably engage the second liner protrusions. The second scale body 342 can have a series of second body recesses 348 that extend the second plate passages 346 if necessary to accommodate the second liner protrusions (not shown).

The second scale body has a second body recess 350 configured to accommodate one of the supplementary tools (320, 322), in this case the toothpick 322. The second body recess 350 is partially bounded by the second scale plate 340, and has a second body recess opening 352 through which the toothpick 322 can be inserted into the second scale recess 350 for storage. Again, to more positively retain the toothpick 322 in the second body recess 350, the second scale plate 340 can be formed with a second plate retention spring 354.

In this embodiment, as is the case with several earlier described embodiments, the handle scales (316, 318) have permanent magnets 360 embedded therein. These magnets provide an attractive force between the handle scales (316, 318) to hold them in contact with the core assembly 302. Lateral and rotational motions are prevented by the slidable engagement of the protrusions 310 with the first plate passages 330 and of the protrusions (not shown) beyond the second liner 306 with the second plate passages 346.

Again, the magnets 360 are preferably located in terminal regions 361 of the knife 300 so as to reside substantially superimposed on the portion of the core assembly that is least effected by the opening or closing of the tools or blades 312 of the knife 300. Again, it is beneficial to have a substantial number of the elements of the core assembly 302 be ferromagnetic to strengthen the magnetic coupling between the spaced-apart magnets 360 when they are engaged with the core 302

In this embodiment, rather than a pair of magnets 360 being employed for each handle scale, three magnets 360 are employed. The use of a pair of smaller magnets 362 allows space for the first and second body recesses (334, 350) to be provided in the scale bodies (326, 342) which will accommodate either the pair of tweezers 320 or the tooth pick 322.

In this embodiment, the pair of smaller magnets 362 off-set and positioned closer to spring bars (not shown) which are ferro-magnetic and thus enhance the coupling between the opposed magnets.

While the novel features of the present invention have been described in terms of particular embodiments and preferred applications, it should be appreciated by one skilled in the art that substitution of materials and modification of details can be made without departing from the spirit of the invention.

What I claim is:

1. A folding tool comprising:
a core assembly having,
a substantially planar first liner,
a substantially planar second liner,
two pins attaching between said liners and maintaining them in a substantially parallel and spaced-apart relationship, said two pins extending beyond said substantially planar liners to provide an array of first liner protrusions extending from said first liner and an array of second liner protrusions extending from said second liner,
at least one blade pivotably mounted on one of said pins so as to be movable between a closed position, where it resides between said first and second liners, and an open position, where it extends substantially beyond said first and second liners,
a first handle scale having a first base surface that is configured to mate against said first liner and having an array first scale recesses located and configured to accept and engage said first liner protrusions when said first base surface is mated against said first liner and fully superimposed thereon;
a second handle scale having a second base surface that is configured to mate against said second liner and having an array of second scale recesses located and configured to accept and engage said second liner protrusions when said second base surface is mated against said second liner and fully superimposed thereon; and
at least one permanent magnet incorporated into each of said handle scales for providing a magnetic moment between said first handle scale and said second handle scale such that said first handle scale and said second handle scale are attracted so as to forcibly engage said first and said second base surfaces respectively against said first and second liners when said first and said second base surfaces are placed in close proximity thereto.

2. The folding tool of claim 1 wherein said first handle scale and said second handle scale are formed of a non-magnetic material, further wherein said at least one permanent magnet for providing a magnetic moment is provided by at least one magnet embedded in each of said handle scales and positioned to draw said handle scales together when brought into close proximity to said liners.

3. The folding tool of claim 2 wherein each of said at least one magnet embedded in each of said handle scales further comprises:
a pair of spaced-apart magnets in each of said handle scales.

4. The folding tool of claim 3 wherein at least a portion of said core assembly is formed from a ferromagnetic material, the folding tool further comprising;
a third pin which extends beyond said substantially planar liners to form a part of said array of first liner protrusions and said array of second linear protrusions;
a first scale third recess in said first handle scale configured to accept said first liner protrusion formed by said third pin; and
a second scale third recess in said second handle scale configured to accept said second liner protrusion formed by said third pin.

5. The folding tool of claim 4 further comprising:
a bushing of durable, abrasion-resistant material lining each of said recesses.

6. The folding tool of claim 5 wherein said at least one magnet is a rare earth magnet.

7. The folding tool of claim 6 wherein said at least one magnet is a neodymium magnet.

8. The folding tool of claim 2 wherein said handle scales are formed from wood and each of said recesses is fitted with a bushing formed from durable, abrasion-resistant material.

9. The folding tool of claim 1 wherein said first handle scale and said second handle scale further comprise scale plates affixed to scale bodies, said scale plates terminating in said base surfaces and said scale bodies being formed of a non-magnetic material, and
further wherein said at least one permanent magnet for providing a magnetic moment is provided by at least one magnet embedded in each of said scale bodies and positioned to draw said handle scales together when brought into close proximity to said liners.

10. The folding tool of claim 9 wherein said scales plates are fabricated from a durable, abrasion-resistant material and each have series of plate passages configured to slidably engage said liner protrusions and forming a portion of said scale recesses.

11. The folding tool of claim 10 wherein said scale plates are fabricated from a ferromagnetic material.

12. The folding tool of claim 11 wherein the tool has terminal end regions and said at least one permanent magnet for providing a magnetic moment further comprises:
a second magnet embedded in each of said scale bodies that compliments said at least one magnet, said magnets residing in said terminal end regions of the tool.

13. The folding tool of claim 12 further comprising:
a pair of scale body recesses residing in said scale bodies and terminating at said scale plates, said pair of scale body recesses being positioned to avoid intersecting said pins and providing openings in the same one of said terminal end regions.

14. The folding tool of claim 13 wherein said at least one permanent magnet for providing a magnetic moment further comprises:
a third magnet embedded in each of said scale bodies and paired with said second magnet, said third magnet and said second magnet both residing in the one of said terminal end regions where said openings reside, said paired magnets being further restricted in their position so as not to interfere with said scale body recesses, said paired magnets being smaller than said at least one magnet.

15. A set of replacement handle scales for a folding tool having,
a substantially planar first liner,
a substantially planar second liner,
at least two pins attaching between the liners and maintaining them in a substantially parallel and spaced-apart relationship, the at least two pins extending beyond the first liner so as to form an array of first liner protrusions and extending beyond the second liner so as to form an array of second liner protrusions, and
at least one blade pivotably mounted on one of the pins so as to be movable between a closed position, where it resides between the first and second liners, and an open position, where it extends substantially beyond the first and second liners,
the set of replacement handle scales comprising:
a first handle scale having a first base surface that is configured to mate against said first liner and having an array of first scale recesses located and configured to accept and engage the first liner protrusions when said first base surface is mated against the first liner and fully superimposed thereon;
a second handle scale having a second base surface that is configured to mate against said second liner and having an array of second scale recesses located and configured to accept and engage said second liner protrusions when said second base surface is mated against said second liner and fully superimposed thereon; and
at least one permanent magnet incorporated into each of said handle scales for providing a magnetic moment between said first handle scale and said second handle scale such that said first handle scale and said second handle scale are attracted so as to forcibly engage said first and said second base surfaces respectively against the first and second liners when said first and said second base surfaces are placed in close proximity thereto.

16. The set of replacement handle scales of claim 15 wherein said first handle scale and said second handle scale are formed of a non-magnetic material, further wherein said at least one permanent magnet for providing a magnetic moment is provided by at least one magnet embedded in each of said handle scales and positioned to draw said handle scales together when brought into close proximity to the liners.

17. The set of replacement handle scales of claim 16 wherein each of said at least one magnet embedded in each of said handle scales further comprises:
a pair of spaced-apart magnets in each of said handle scales.

18. The set of replacement handle scales of claim 17 for use when at least a portion of the folding tool is formed from a ferromagnetic material and when the at least two pins are provided by,
a first pin,
a second pin that is positioned at a maximum separation S_{MAX} from the first pin; and
a third pin that is positioned at a minimum separation S_{MIN} from said first pin, and
further when the first liner protrusions are provided by,
a first liner first protrusion formed by the first pin,
a first liner second protrusion formed by the second pin, and
a first liner third protrusion formed by the third pin,
wherein said first scale recesses of said first handle scale further comprise:
a first scale first recess positioned to accept and engage the first liner first protrusion when said first base surface is mated against the first liner and fully superimposed thereon;
a first scale second recess configured to accept and engage the first liner second protrusion when said first base surface is mated against the first liner and fully superimposed thereon;
a first scale third recess configured to accept and engage the first liner third protrusion when said first base surface is mated against the first liner and fully superimposed thereon,
said first scale first recess and said first scale third recess being configured such that said first handle scale can be positioned in an extended position where it is partially superimposed on the first liner with the first liner first protrusion residing in said first scale third recess and the first liner third protrusion residing in said first scale first recess such that a portion of said first handle scale extends beyond the first liner,
one of said at least two first scale magnets being located so as to be positioned against the first liner so as to be attracted to a ferromagnetic portion of the folding tool when said first handle scale is in its extended position,
another of said at least two first scale magnets being located so as to be spaced apart from the first liner when said first handle scale is in its extended position,
whereby one of said at least two second scale magnets can be magnetically engaged against said one of said at least two first scale magnets that is spaced apart from the first liner so as to magnetically attach said second handle scale to said first handle scale.
